(19) United States
(12) Patent Application Publication
(10) Pub. No.: US 2010/0114719 A1
(43) Pub. Date: May 6, 2010

(54) Engine, system and method for generation of advertisements with endorsements and associated editorial content

(76) Inventors: Ryan Steelberg, Irvine, CA (US); Chad Steelberg, Newport Beach, CA (US)

Correspondence Address: Thomas J. McWilliams, Esquire;Drinker Biddle & Reath LLP, One Logan Square, 18th and Cherry Streets, Philadelphia, PA, 19103-6996, US

(21) Appl. No.: 12/455,138

(22) Filed: May 28, 2009

Related U.S. Application Data
(63) Continuation-in-part of application No. 12/144,194, filed on Jun. 23, 2008.
Application No. 12/144,194 is a continuation-in-part of application No. 11/981,646, filed on Oct. 31, 2007.
Application No. 11/981,646 is a continuation-in-part of application No. 11/981,837, filed on Oct. 31, 2007.
Application No. 11/981,837 is a continuation-in-part of application No. 12/072,692, filed on Feb. 27, 2008.
Application No. 12/072,692 is a continuation-in-part of application No. 12/079,769, filed on Mar. 27, 2008.
Application No. 12/079,769 is a continuation-in-part of application No. 12/042,913, filed on Mar. 5, 2008.
Application No. 12/072,692 is a continuation-in-part of application No. 11/981,646, filed on Oct. 31, 2007.
(60) Provisional application No. 60/993,096, filed on Sep. 7, 2007.

(51) Int. Cl. G06Q 30/00

(52) U.S. Cl. 705/14.72

(57) ABSTRACT

An apparatus, system and method for generating endorsed advertisements with editorial content is disclosed. The system may include an endorsements database including endorsements associated with endorsers; a news database including news stories associated with endorsers; a recommendation engine configured to match at least one endorsement from the endorsement database and at least one news story from the news database with at least one advertisement template, the matched news story and endorsement both pertaining to the same endorser; and an integration engine configured to integrate the matched endorsement, the news story, and the advertisement template to generate an advertisement, the generated advertisement including a first link associated with the content of the advertisement template that when selected redirects a web browser to a website of the advertiser and a second link associated with the news story that when selected redirects a web browser to a website presenting the news story.

### CROSS-REFERENCE TO RELATED APPLICATIONS

This application is a continuation-in-part of U.S. patent application Ser. No. 12/144,194, which is: a continuation-in-part of U.S. patent application Ser. No. 11/981,646, entitled “Engine, System and Method for Generation of Brand Affinity Content”, filed Oct. 31, 2007; a continuation-in-part of U.S. patent application Ser. No. 11/981,837, entitled “An Advertising Request And Rules-Based Content Provision Engine, System and Method”, filed Oct. 31, 2007; a continuation-in-part of U.S. patent application Ser. No. 12/072,692, entitled “Engine, System and Method For Generation of Brand Affinity Content, filed Feb. 27, 2008; and a continuation in part of U.S. patent application Ser. No. 12/079,769, entitled “Engine, System and Method for Generation of Brand, Affinity Content,” filed Mar. 27, 2008, the disclosures of which are incorporated by reference herein as if set forth in their entirety.

### BACKGROUND OF THE INVENTION

1. Field of the Invention

The present invention is directed to a system and method for generating advertisements with endorsements and associated news, and methods of making and using the same.

2. Description of the Background

Advertisers often purchase advertisements to persuade a consumer to purchase a good or service. The advertiser would like the advertisement to have the greatest impact on the consumer to increase the likelihood that the consumer will purchase the good or service. The impact of an advertisement may be increased by an endorsement for the advertisement. For example, an automotive company may hire a professional athlete to appear in an advertisement for one of its automobiles. The consumer may be more likely to purchase the automobile if the consumer likes the professional athlete. However, it may be difficult for an advertiser to match an endorsement with the consumer it is trying to persuade to purchase the advertised good or service and it may be difficult for the advertiser to maximize the impact of the particular endorsement to the consumer. For example, the consumer may simple ignore the advertisement, in rare cases even if the advertisement includes an endorsement by a person the consumer respects.

Thus there is a need in the art to increase the impact of advertisements and in particular improve the ability of advertisers to match an advertisement with an endorsement such that the persuasive power of the endorsement is optimized.

### SUMMARY OF THE INVENTION

The present invention is and includes a computing apparatus, system and method for generating endorsed advertisements including editorial content. This apparatus, system and method includes an endorsements database including at least one media associated with at least two endorsers, a news database including editorial content associated with at least one of the at least two endorsers, a recommendation engine configured to match at least one of the at least one media and at least one of the editorial content with at least one advertisement template, and an integration engine configured to integrate the matches from said recommendation engine to generate an advertisement. The generated advertisement may include a first link associated with the advertisement template for redirecting a web browser viewing the generated advertisement to an advertiser associated with the generated advertisement, and a second link associated with the editorial content for redirecting the web browser to the editorial content.

Thereby, the present invention provides an increase in the impact of advertisements, and in particular improves the ability of advertisers to match an advertisement with an endorsement such that the persuasive power of the endorsement is optimized.

### BRIEF DESCRIPTION OF THE DRAWINGS

Understanding of the present invention will be facilitated by consideration of the following detailed description of the embodiments of the present invention taken in conjunction with the accompanying drawings, in which like numerals refer to like parts and in which:

FIG. 1 is a example of the operation of an embodiment of the present invention;

FIG. 2 is an example of a schematic diagram of an embodiment of the present invention;

FIG. 3 illustrates an example of a schematic diagram of an embodiment of the recommendation engine;

FIG. 4 illustrates an example of the operation of the present invention;

FIG. 5 illustrates an example of the operation of the present invention;

FIG. 6 illustrates a method for generating advertisements with endorsements and associated news; and

FIG. 7 is an example of a simplified functional block diagram of a computer system.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in typical computer and networking applications, and computing apparatuses, systems and methods. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention:

Embodiments of the present invention provide methods and apparatuses for generating endorsed advertisements associated with editorials, articles, blogs, news, or the like (hereinafter also referred to collectively as “news”). The system may include a database, also referred to as a vault or an endorsement database, that includes endorsements and media associated with endorsers; a news database including news, which news database may be relational with the endorsement database in order to relate news as associated with particular endorsers; a recommendation engine configured to match at least one endorsement from the endorsement database and at least one news story from the news database with at least one advertisement template, wherein the matched news story and endorsement both pertain to the same endorser; and an integration engine configured to integrate the matched endorsement, the news story, and the advertisement template to generate an advertisement, the generated advertisement including a first link associated with the content of the advertisement template such that, when the first link is selected it redirects a web browser to a website of the advertiser; and a second link associated with the news story that, when selected, redirects a web browser to a website presenting the news story. As used herein, the term link includes at least one code or content set for the purpose of moving to a new at least one code or content set or for bringing in information or content from the new at least one code or content set. The at least one code or content, set, may be either local or remote, online or offline, and may, for example, be a hyperlink as that term is commonly used within the art,

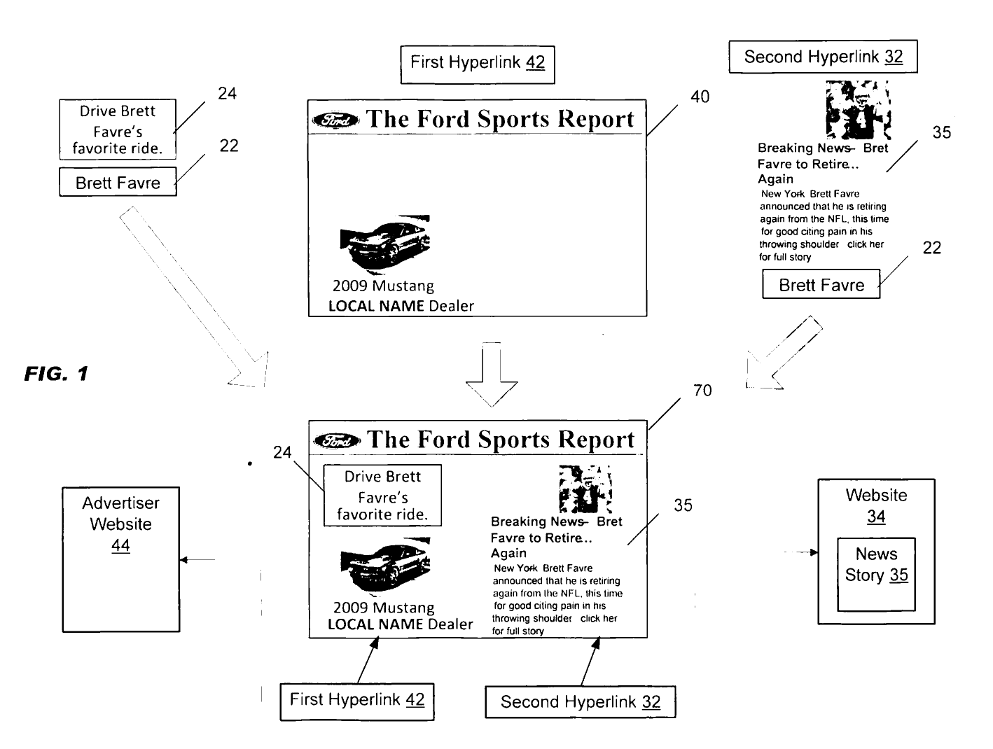

FIG. 1 illustrates an example of the operation of the present invention. An advertisement template 40 is matched with: (1) an endorsement 25 from Brett Favre 22 with media 24 for the endorsement 25, and (2) current news 35 regarding Brett Favre 22. The matching may be made to maximize the impact of the advertisement 70 on targeted consumers of the advertisement 70. The advertisement template 40 with the first link 42, the media 24 of the endorsement 25, and the news story 35 with the second link 32 are integrated into an advertisement 70 for displaying on a website (not illustrated.). In certain embodiments, the news may be generated by, archived on, or otherwise associated with, the website on which the advertisement is displayed, such as to alleviate any copyright or competition issues. The advertisement 70 may be constructed so that the consumer of the advertisement 70 may click on the area of the advertisement 70 associated with the advertisement template 40 to be taken to a landing advertiser website 44, and so that the consumer may click on the news story 35 to be taken to a landing website 34 which offers the full news story 35. By combining an endorsement 25 and a news story 35 regarding the same endorser 22, the impact to the targeted consumer of the advertisement 70 may be optimized.

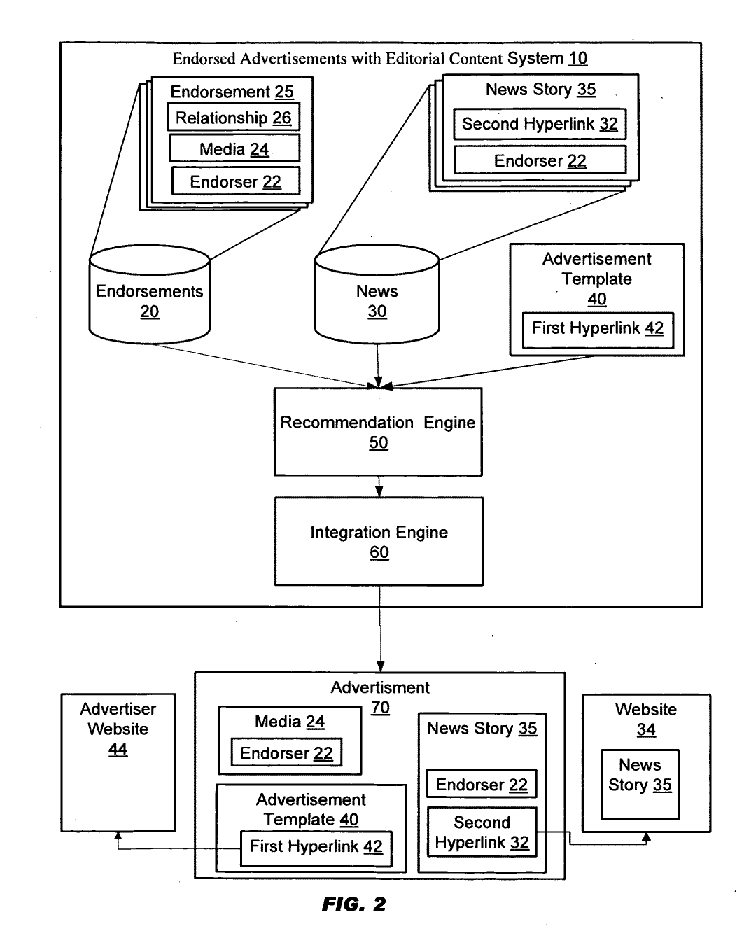

FIG. 2 illustrates a system for generating advertisements with endorsements and associated news 10 according to an embodiment of the present invention. The system 10 includes the endorsements database 20, which may include at least endorsements 25 with associated endorsers 22, media 24, and relationships 26; a news database 30 including news 35 associated with endorsers 22, second links 32; an advertisement template 40 with an associated first link 42; a recommendation engine 50; and an integration engine 60.

The endorsements database 20 includes endorsements 25 associated with endorsers 22, media 24 which may be associated with endorsers 22 and/or endorsements 25, and relationships 26. An endorser 22 may be a specific individual, a specific entity, an affinity brand, a marketing partner, or a sponsor, for example. The media 24 may be audio, text, and/or audio visual content associated with the endorser 22 and/or endorsement 25 within the endorsement database/vault 20. For example, as discussed in FIG. 1, the endorser 22 may be a professional football player and the endorsement 25 may include media 24 of the professional football player playing, smiling while waving, or advocating use of a particular brand of automobile, which media 24 may be suitable for being incorporated into a banner advertisement for display on a website, for example. The media 24 may include, but is not limited to, video, pictures, voice, audio, metadata associated with any media form, symbols, emblems, taglines, press releases, publications, web links, and web links to external content. The media 24 may be capable of re-purposing for use with the advertising template 40. For example, an athlete running in front of a blue screen may be media re-purposed for use with the advertising template 40 by the placement of a background over the blue screen. The media 24 may be provided by the endorser 22 or may be public domain media 24, or media 24 the rights to which are owned by a third party, and the media may be stored within the vault or endorsement database, stored in association with the vault or remote database, or may be accessed remotely via a link for mash up in an editorial advertisement, such as by an advertising server, upon formulation of an advertisement to be placed.

The relationship 26 of the endorsement 25 may include, but is not limited to: (1) endorsements or sponsorships, in which the endorser 22 may be used by the advertiser to market another product or service to improve the marketability of that other product or service; (2) marketing partnerships, in which short term relationships between different products or services are employed by the advertiser to improve the marketing of each respective product or service; and (3) brand affinity, which is built around a long-term relationship between different products or services such that, over time, consumers come to accept an affinity of one brand based on its typical placement with another brand in another or related industry. The relationship 26 may permit a single use of media 24, or may include a longer term commitment or option of use by the endorser 22 and/or the advertiser. The relationship 25 may include prices for the use of the endorsement 25, and/or preapproved, or automatically approved, goods or services for use of the endorsement 25. Such preapprovals may form a rule set with regard to each endorser, thereby, for example, becoming media assets within the vault or endorsement database. The endorsers 22 may thus have committed to the relationship 26 of the endorsements 25 without further permission. The relationship 26 may include exclusions, inclusions, and/or preferences on the use of the endorsement 25 and/or may require approval of the endorser 22 before the advertiser uses the endorsement 25. Such relationships 26 may similarly be incorporated into a rule set as a media asset associated with each available endorser. Such inclusions, exclusions, preferences, or approvals may be based on geography, time, product or service, existing relationships, affiliations, or sponsorships, or the like, for example. For example, a professional football player may agree to endorsements for local automotive dealerships with a specific brand of automobile and exclude all other uses of the endorsement 25. The professional football player may similarly provide certain media 24 with content suitable for specific uses, such as in banner advertising on websites, for example.

The news database 30 may include news 35 and events associated with endorsers 22 in the endorsements 20 database. For example, a news story 35 may be that the professional football player discussed above is about to retire as illustrated in FIG. 1. The news story 35 may have been retrieved or received from a news service such as Associated Press®, and/or from a website onto which the news 35 is to be placed in association with an endorsement 25. The second link 32 may be associated with the news story 35, and, in certain embodiment, may be a website at which the news story 35 is currently being presented. For example, the second link 32 may be a link 32 to the Associated Press's website. The events associated with endorsers 22 may be an event that is related to the endorser 22. For example, the event may be a game in which a professional football player is going to play, or has played, such as a game summary or a box score. As another example, an event may be the opening of an exhibit that the endorser 22 designed or organized, but at which the endorser 22 will not attend. The news story 35 may be a shortened version of a full new story 35. The news story 35 may have language such as “To see full story click here” appended to and/or associated with the news story 35. The system 10 may actively search external sources, including websites, for news stories 35 and/or events, and/or the system 10 may receive the news stories 35 and/or events from external sources including websites.

The advertisement template 40 with an associated first link 42 may be a creative advertisement template 42 that may be modifiable to include an endorsement 25 and a news story 35. The first link 42 may be a link 42 that, when clicked, redirects a web browser to the advertiser website 44. As will be appreciated by those skilled in the art, a link may avail the user to any form of media which may be provided to the user. Links may be associated with social networks, blogs, RSS feeds, correspondence vehicles, such as email, video, music, premium content services, or any media and/or information source. For example, a news story 35 may be a video short of a sports endorser from a local news program. Further still, a link may provide driving directions/GPS and timing information about where an endorser may be appearing, for example.

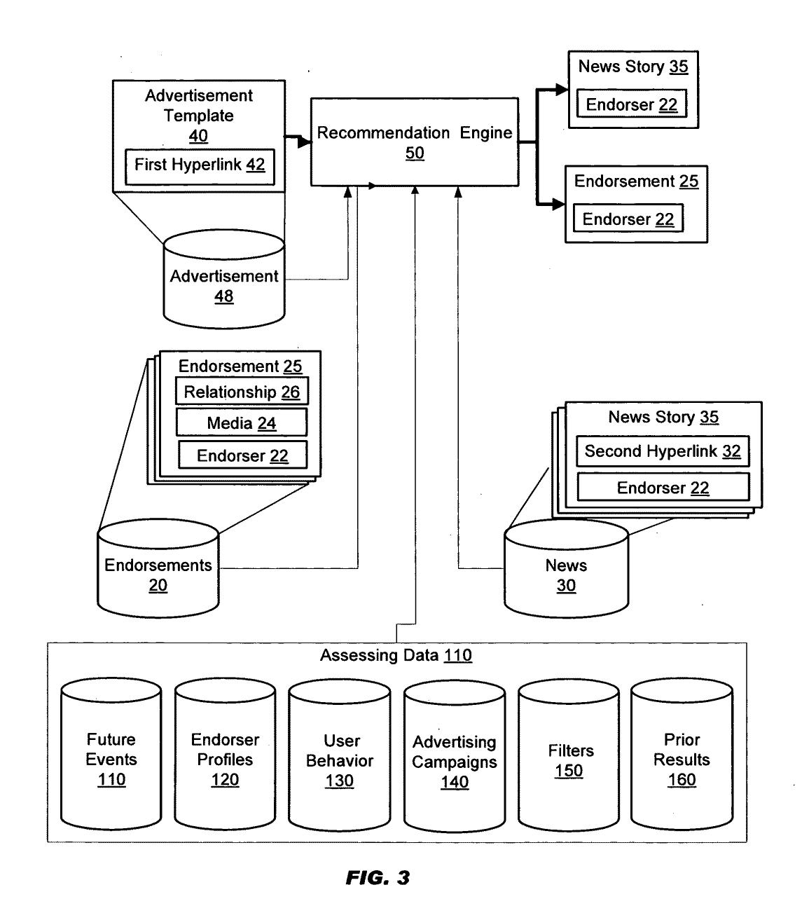

The recommendation engine 50 may match an advertisement template 40 with an endorsement 25 and a news story 35 with the same endorser 22. For example, referring now again to FIG. 1, the recommendation engine 50 may match an advertisement template 40 for a local car dealership with a first link 42 to the local dealership's website, and with an endorsement 25 from a professional football player for a brand of automobile sold by that local dealership. The recommendation engine 50 may further match news 35 regarding the professional football player with the advertisement template 40 and/or the endorsement 25. As will be discussed below, the recommendation engine 50 may assess, based on numerous factors including external factors, the endorsement 25 and the news 35 most sensible for a particular advertisement template 40. The recommendation engine 50 may automatically perform matching, or the recommendation engine 50 may match under the direct direction of a user. The recommendation engine 50 is discussed further in relation to FIG. 3.

The integration engine 60 integrates the advertisement template 40 with associated first link 42, media 24 of the matched endorsement 25, and the matched news story 35 with associated second link 32, to generate, an advertisement 70. The integration engine 60 may be configured to create a shortened version of the news story 35 so that the news story 35 may be adapted for the advertising template 40. The advertisement 70 may be suitable for being transmitted across an electronic network for display on a website. The integration engine 60 may provide for late stage binding of advertisement 70. As such, the integration engine may be, for example, an advertisement server as will be appreciated by those skilled in the art. Thereby, the advertisement server may be under unified control, wherein a mash up of the endorser, the ad, and the editorial/news may be performed by the ad server based on an accessing, by the ad server, of one or more environments in which are present or stored the endorser media, the ad and the editorial/news. Additionally and alternatively, such a mashup may be performed by the integration engine separately from, and prior to forwarding to, an ad server, and in such an embodiment the ad server may serve exclusively to deliver the mashed up advertisement.

Thus the system 10 is enabled to create advertisements 70 that may have a greater impact on targeted consumers by combining an endorsement 25 and a news story 35 regarding the same endorser 22 with an advertising template 40.

FIG. 3 illustrates an example of a schematic diagram of an embodiment of the recommendation engine illustrating data that may be used by the recommendation engine to assess news stories, endorsements, and advertising templates, both independently and for appropriate matches.

Illustrated in FIG. 3 is a recommendation engine 50, advertisement template 40, advertisement database 48, news story 35, endorsement 25, endorsements database 20, news database 30, and assessing database 110. The recommendation engine 50 may assess the endorsements 25, the news stories 35, and the advertisement template 40 based on the advertisement database 48, the endorsements database 20, the news database 30, and the assessing database 110. The assessments may be used to match an advertisement template 40, with a news story 35, and with an endorsement 25. The match may be done automatically or under the direction of a user and/or internal or external program.

The advertisement database 48 may include costs of advertisements, size of advertisements, contractual limitations on the use of advertisements, etc., that may all be used by the recommendation engine 50 to assess the appropriateness of matches. The endorsement database 20 may also include costs of endorsements 25, contractual limitations on the use of endorsements 25, etc., that may all be used by the recommendation engine 50 to assess the appropriateness of matches.

The news database 30 may include web addresses where the news stories 35 are being presented, relationship between new stories 35, the duration news stories 35 have been playing, etc. The news database 30 may include categories where news stories 35 are placed. The data in the news database 30 may be used by the recommendation engine 50 to assess the appropriateness of matches. The recommendation engine 50 may assess a news story 35 based on the ability of the integration engine 60 to shorten the news story 35 to adapt the news story 35 to the advertisement template 40.

The assessing database 110 may include future events database 120, brand profiles 120, endorser profiles 120, user behavior database 130, advertising campaigns 140, filters database 150, and prior results database 160.

The future events database 110 may include, but is not limited to or by, future events and information that is predictive of future events for the recommendation engine 50 to use for making assessments. For example, future events database 110 may include the schedule of a particular Major League Baseball starting pitcher including locations, days and game start times for that pitcher. Based on this identified schedule, the recommendation engine 50 can partially base an assessment of news 35 regarding the health of the particular starting pitcher for matching with an endorsement 25 from the particular starting pitcher and an advertisement template 40. The future events database 110 may include percentage chances of future events to occur based on collected data of past events, and provide the recommendation engine 50 the ability to assess endorsers 22 and/or new stories 35 based on the probability of future events 110 occurring. Likewise, the future events database may track, and allow for tracking of, endorser ratings, endorser performance in the endorser's arena, or performance of the endorser as an endorser, either manually or automatically, such as based on positive and negative Web mentions, and in such embodiments this tracking may allow for a rating of endorsers versus time, geography, news on that endorser, both at present and into the future. As such, the future events database may be part of, or may be associated with, the vault/endorsement database, and thereby tracking aspects may, in certain exemplary embodiments, form media assets for association with each endorser.

The endorser profiles database 120 may include, but is not limited to or by, psychological profiles of typical users of or fans of endorsers (which may include values, motivations, wants, and needs of such users, and which may be assessed based on inferences from activity data, such as on-line, credit card, or television use by those users, for example), endorser profiles including target customers and/or fans, target affiliate profiles (which may include reasons for desired affiliation, such as sharing marketing costs, increasing endorser recognition in certain geographies or fields of use, distribution channel access, expedited market entry, or improved endorser perception, for example), and the like. Polling results and/or metadata may provide for local or national focus of assessing matching, and the assessment of matches for certain endorsers with advertisers may be made according to such polling results or associated metadata. For example, a “flashy” sports personality may have a high assessment for an advertiser offering in Los Angeles, but a different athlete's endorsement might be preferable to sell that advertiser's offering in the mid-west. Such information, including “who's hot”, or where an endorser is “hot”, may be used by the recommendation engine for assessment. Thus, the endorser profiles database may, in certain embodiments, form part of, or be associated with, the future events database and/or the vault/endorsement database.

User behavior database 130 may include the selections made by the users of the system 10. For example, news stories 35 previously selected by a user of the system 10 may be used to compute a similarity with news stories 35 being assessed by the recommendation engine 50. The recommendation engine 50 may assess the news stories 35 that are more similar to previously selected news stories 35 with a higher value.

The advertising campaigns database 140 may include information for advertising campaigns the advertiser is using or has used. Additionally, the advertising campaigns database 140 may include information about other advertising campaigns running or that have run. The recommendation engine 50 may use the advertising campaign database 140 by assessing how compatible the advertisement template 40, the news story 35, and/or the endorsement 25 is with advertising campaigns in the advertising campaigns database 140. For example, the recommendation engine 50 may assess the impact of a news story 35 regarding a professional athlete as low if there are many similar advertisements 70 currently being run by competing advertisers.

The filters database 150 may include filters that can be used to exclude or include data and/or assessment criteria from an assessment of the recommendation engine 50. For example, an advertiser may have determined that a particular baseball pitcher would be good as an endorser of its product, and may thus use a filter that only includes that particular baseball pitcher in assessing matches.

The prior results database 160 may include the results of previous advertisements, including data for the various combinations of endorser, advertisement template, and news story. The prior results database 160 may include categories for measuring the previous results of previous advertisements. The prior results database 160 may include data related to reporting impressions, clicks, post-click and post-impression activities, and may include additional interaction metrics. As such, the prior results database may, in certain embodiments, be associated with, or form part of, one or more of the endorser profiles database, the future results database, and the vault/endorsement database. The recommendation engine 50 may use the prior results database 170 for assessments by comparing a target match with the advertisements that were previously used and the results of playing the previously used advertisements.

The recommendation engine 50 may normalize the assessment values to remove variations such as time of day variations. Other variations, such as seasonal variations, weekly variations and general topic variations can also be normalized out. Ratios and difference measurements might also be performed in comparing two or more data to determine relative assessment.

The data may include internal and external references. For example, the future events 120 database may include an external reference to a webpage where a team's schedule is located. The recommendation engine 50 may either directly or indirectly retrieve the information from the external reference.

According to yet another aspect of the present invention, the recommendation engine 50 may be used for identifying and recommending an advertisement template 40 based on selected news 35 and/or endorser 22.

Thus, the recommendation engine 50 may assess the best matches for a particular advertisement template 40 based on the data described above, such as that data present in one or more of the prior results database, the endorser profiles database, the future results database, and the vault/endorsement database. Upon assessment of good matches for the advertisement template 40, a user may have the matching options presented for selection by the recommendation engine 50, or the user may simply have a best-match and/or best-value selection made automatically for the user. The recommendation engine 50 may assess matches based on pairs of news stories 35 and endorsements 25. In general, the recommendation engine 50 may start with any selection by the user and assess matches with the selection. For example, the user may select a professional baseball team, and based on the selection, the recommendation engine 50 may assess the potential impact and/or cost of using all possible advertisement templates 40 with all possible news stories 35 and all possible endorsements 25 that include the professional baseball team. Then, based on the assessments, the recommendation engine 50 may present the user with an order list of triples of advertisement templates 40, news stories 35, and endorsements 25, that include the selected professional baseball team, and that may include assessments of costs and potential impact to the consumer that the advertiser is trying to sell its good or service.

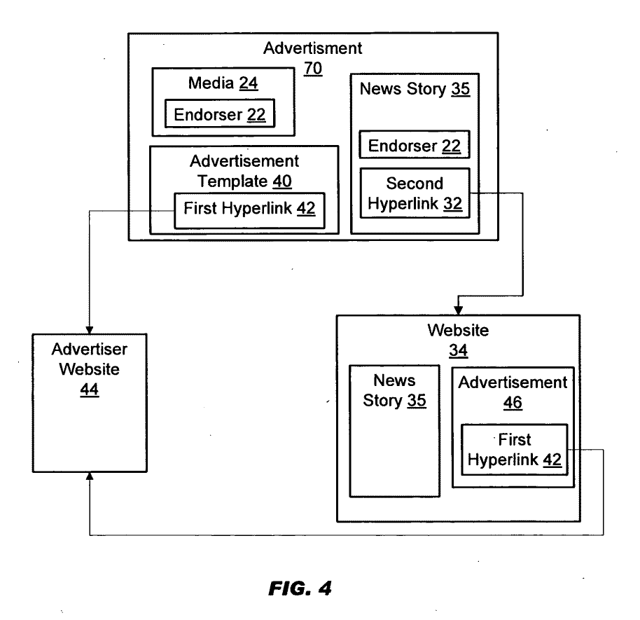

FIG. 4 illustrates an example of the operation of an aspect of the present invention. Illustrated in FIG. 4 is an advertisement 70, an advertisement website 44, and a website 34. The website 34 is configured to present both the news story 35 and an advertisement 46 that is associated with the advertisement 70. The advertisement 46 may be associated with the first link 42 which, when selected, will re-direct a web browser to the advertiser website 44. The second link 32 may include information for serving the advertisement 46 to the website 34. The integration engine 60 (as described with FIG. 2) may be configured to create the advertisement 46 and/or the website 34.

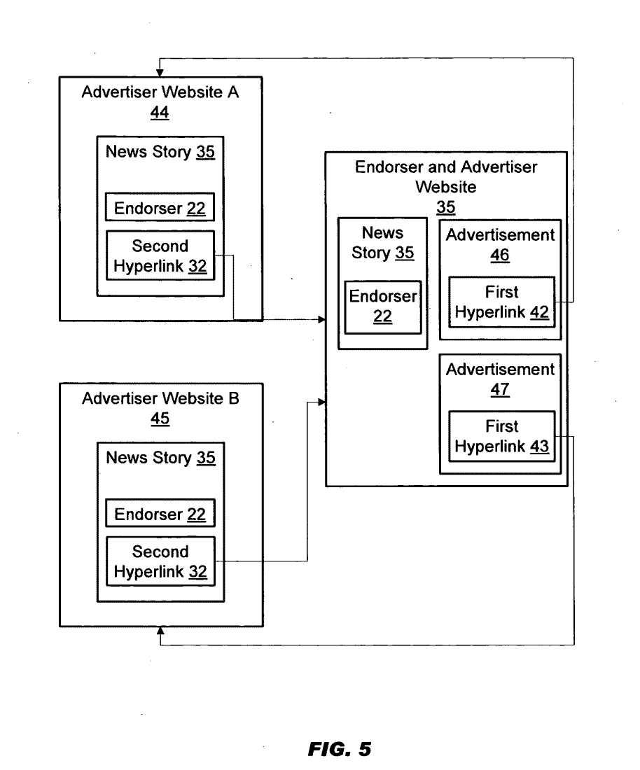

FIG. 5 illustrates an example of the operation of an aspect of the present invention. Illustrated in FIG. 5 is an endorser and advertiser website page 35, advertiser website A 44, and advertiser website B 45. Advertiser website A 44 and advertiser website B 45 may be advertiser websites. Advertiser generator website 35 may be a website generated by the system 10. The advertiser generator website 35 may be a website 35 that includes a news story 35 regarding an endorser 22, and, for at least two advertisers that are using the endorser 22, advertisements 46, 47, which include first links 42, 43 that when selected redirect a web browser to the respective advertisers' website 44, 45. The advertiser's website 44, 45 may present the same news story 35, which may be a shorted version of the news story 35, on websites 44, 45 with second links 32, which second links, when selected, redirect a web browser to the endorser and/or advertiser website 35. In this way, a user may see the advertisers that have been endorsed by the endorser 22, and the user can be conveniently redirected to the advertiser's websites. The integration engine 60 (as described with FIG. 2) may be configured to generate the endorser and advertiser website 35.

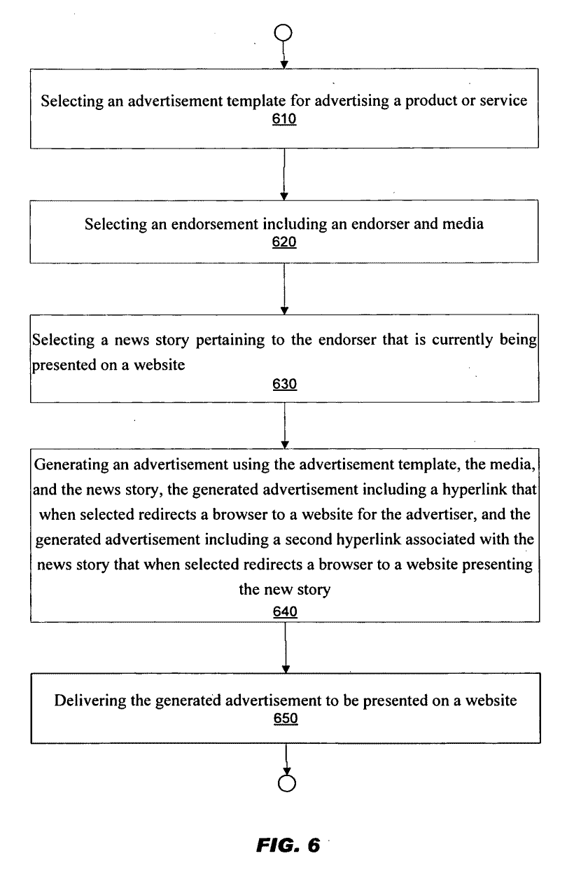

FIG. 6 illustrates a method for generating advertisements with endorsements and associated news. The method may begin with selecting an advertisement template for advertising a product or service. An advertiser may select an advertising template for matching with an endorsement and a news story. The method may continue with selecting an endorsement including an endorser and media. The endorsement may be selected automatically, or choices may be presented to an advertiser with assessments values and the advertiser may select the endorsement. The method may continue with selecting a news story pertaining to the endorser that is currently being presented on a website. A news story may be selected automatically pertaining to the endorser, or choices may be presented to an advertiser with assessment values and the advertiser may select the new story. Alternatively, the news story may be selected first and then the endorser may be selected. Alternatively, news story and endorsement pairs may be selected automatically and/or presented to the advertiser with assessments and the advertiser may choose a pair. The method may continue with generating an advertisement using the advertisement template, the media, and the news story, the generated advertisement including a link that, when selected, redirects a browser to a website for the advertiser, and the generated advertisement may also include a second link associated with the news story that, when selected, redirects a browser to a website presenting the new story. The advertisement may be generated automatically as discussed with FIG. 2. The method may continue with delivering the generated advertisement for presentation, such as on a website. The generated advertisement may be delivered to a website for presentation to a consumer.

By way of further example, a link within an endorsed ad may link a user to a news story about the endorser of the advertisement and/or to information about the endorsed product itself. For example, an endorsed ad featuring a professional athlete and a line of trucks for sale may include a link to an unendorsed ad that features information about the trucks. A further link may be provided which may provide editorial solely about the professional athlete. Such an editorial may be directed to his/her interest in trucks, professional career, and/or personal gossip, for example. Conversely, as discussed in greater detail above, an advertisement may include a link to information regarding an endorser of the product. In similar fashion, the link may provide the user with another endorsed ad, news about the endorser sans mention of the endorsed product, and/or news about the endorser's affinity for the endorsed product.

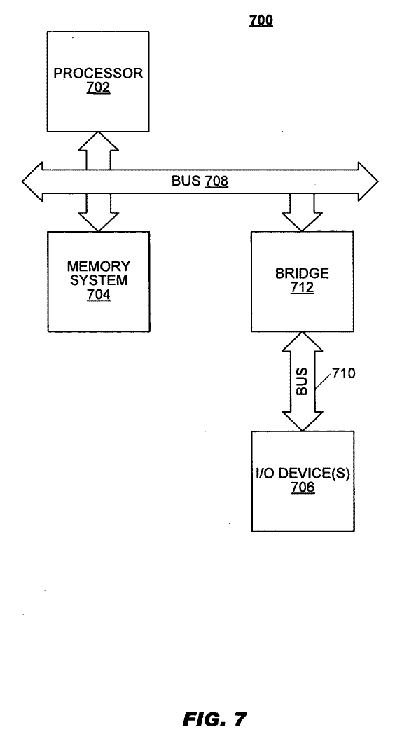

FIG. 7 is an example of a simplified functional block diagram of a computer system 700. The functional descriptions of the present invention can be implemented in hardware, software or some combination thereof. For example, a recommendation engine and an integration engine of the present invention can be implemented using a computer system including one or more processors and memory.

As shown in FIG. 7, the computer system 700 includes a processor 702, a memory system 704 and one or more input/output (I/O) devices 706 in communication via a communication ‘fabric’, such as a bus. The communication fabric can be implemented in a variety of ways and may include one or more computer buses 708, 710 and/or bridge and/or router devices 712, as shown in FIG. 7. The I/O devices 706 can include network adapters and/or mass storage devices from which the computer system 700 can send and receive data for generating and transmitting advertisements with endorsements and associated news. The computer system 700 may be in communication with the Internet via the I/O devices 708.

The various illustrative logics, logical blocks, modules, data stores, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

Those of ordinary skill in the art will recognize that many modifications and variations of the present invention may be implemented without departing from the spirit or scope of the invention. Thus, it is intended that the present invention cover the modifications and variations of this invention provided they come within the scope of the appended claims and their equivalents.

1. A computer system for generating endorsed advertisements comprising:
an endorsements database including computer data indicative of at least one media associated with at least two endorsers;
a news database including computer data indicative of editorial content associated with at least one of the at least two endorsers;
a recommendation engine associated with at least one processor and configured to match at least one of the at least one media and at least one of the editorial content with at least one advertisement template; and
an integration engine associated with the at least one processor and configured to integrate the matches from said recommendation engine to generate an advertisement, the generated advertisement comprising:
a first link associated with the advertisement template for redirecting, over a computer communications network, a viewer of the generated advertisement to an advertiser associated with the generated advertisement; and
a second link associated with the editorial content for redirecting the viewer to the editorial content.

2. The computer system of claim 1, wherein a website presenting the editorial content includes at least part of the editorial content and a second advertisement including the first link.

3. The computer system of claim 2, wherein the second link includes information for retrieving the second advertisement.

4. The computer system of claim 1, wherein the integration engine is further configured to generate an endorser and advertiser website page, including the editorial content, and at least two advertisements from advertisers that have selected the endorser.

5. The computer system of claim 1, wherein the website presenting the editorial content is a third party website of a news organization.

6. The computer system of claim 1, wherein, in the generated advertisement, the editorial content comprises a partial editorial content, and wherein a user receives the full editorial content by selecting the second link.

7. A computerized method for generating an advertisement, comprising:
selecting a computer readable advertisement template for advertising at least one of a product and a service;
selecting an endorsement including an endorser and computer data indicative of at least one media;
selecting a news story pertaining to the endorser that is currently being presented on a website;
generating an advertisement comprising the advertisement template, the at least one media, and the news story, the generated advertisement including a first link that, when selected, redirects over a computerized communications network to a website for an advertiser of the advertisement, and the generated advertisement including a second link associated with the news story that, when selected, redirects to a webpage presenting a full version of the news story;
delivering, over the computerized communications network, the generated advertisement for presentation on a website.

8. The method on a computer of claim 7, wherein the webpage presenting the full version news story includes an advertisement for the advertiser with an associated first link that, when selected in a web browser, redirects the web browser to the advertiser website.

9. The method on a computer of claim 7, wherein the second link includes information for retrieving the second advertisement.

10. The method on a computer of claim 7, further comprising:
generating an endorser and advertiser website page including the news story and at least two advertisements from secondary advertisers that have selected the endorser, the secondary advertisements from the secondary advertisers including a link that, when selected, redirects the web browser to a webpage of the secondary advertiser; and
generating the news story with a link that, when selected, redirects the web browser to the endorser and advertiser website page.

11. The method on a computer of claim 7, wherein the website presenting the news story is a third party website of a news organization.

12. A computer system for generating endorsed advertisements, comprising:
at least one database comprising computer data indicative of at least one media associated with at least two endorsers, and editorial content associated with at least one of the at least two endorsers;
a recommendation engine associated with at least one processor for matching at least one of the at least one media and at least one of the editorial content with at least one advertisement template; and
an integration engine associated with the at least one processor that integrates the matches from said recommendation engine and correspondingly generates an advertisement, the generated advertisement comprising:
a first link associated with the advertisement template for redirecting, over a computer communications network, a viewer of the generated advertisement to a network site for an advertiser associated with the generated advertisement; and
a second link associated with the editorial content for redirecting the viewer to a second network site having resident thereon the editorial content among a plurality of available editorial content.

13. The computer system of claim 12, wherein the network site presenting the editorial content includes at least part of the editorial content and a second advertisement including the first link.

14. The computer system of claim 13, wherein the second link includes information for retrieving the second advertisement.

15. The computer system of claim 12, wherein the integration engine is further configured to generate an endorser and advertiser website page, including the editorial content, and at least two advertisements from advertisers that have selected the endorser.

16. The computer system of claim 12, wherein the second network site presenting the editorial content is a third party website of a news organization.

17. The computer system of claim 12, wherein, in the generated advertisement, the editorial content comprises a partial editorial content, and wherein a user receives the full editorial content by selecting the second link.

18. The computer system of claim 12, wherein a full version news story representing the editorial content includes an advertisement for the advertiser associated with the first link that, when selected in a web browser, redirects the web browser to the advertiser website.

19. The computer system of claim 12, wherein the second link includes information for retrieving a second advertisement.

20. The computer system of claim 12, wherein said at least one database comprises at least two databases, and wherein one of said at least two databases comprises a news feed.
